(19) United States
(12) Patent Application Publication
(10) Pub. No.: US 2007/0107984 A1
(43) Pub. Date: May 17, 2007

(54) Fall arrest system

(75) Inventor: Timothy George Bissett, Wiltshire (GB)

Correspondence Address: BROOKS KUSHMAN P.C., 1000 TOWN CENTER, TWENTY-SECOND FLOOR, SOUTHFIELD, MI, 48075, US

(73) Assignee: LATCHWAYS PLC, WILTSHIRE (GB)

(21) Appl. No.: 10/595,612

(22) PCT Filed: Nov. 1, 2004
(86) PCT No.: PCT/GB04/04607

§ 371 Date: May 1, 2006

(30) Foreign Application Priority Data
Oct. 30, 2003 (GB) 0325394.5

(51) Int. Cl. E06C 7/18

(52) U.S. Cl. 182/3

(57) ABSTRACT

A fall arrest system is formed by a vertical cable extending between an upper anchor point and a lower anchor point and a fall arrest device arranged for movement along the cable. An energy absorbing means is associated with the upper anchor point to reduce the forces applied to the anchor point when a fall is arrested.

The present invention relates to a fall arrest system for use when working on buildings and the like.

Typically, such fall arrest systems include a vertical cable tensioned between a top and bottom anchor and, usually, cable guide means extending from a vertical wall. Also used with the system are one or more fall arrest devices that are connected to a worker and clipped or otherwise connected to move along the cable. The fall arrest device or devices each include a braking means arranged to respond to a fall by gripping or locking onto the cable to prevent rapid descent of a worker should they fall from their working position.

It has been discovered through testing that in a vertical fall arrest system including a cable tethered by a top and bottom anchor and pre-tensioned to a predetermined value, when a fall arrest occurs the force acting on the top anchor can be up to three times the force acting on the falling worker (under gravity).

It is believed that this increase in the force acting on the top anchor arises from a combination of a standing wave effect, also known as a stationary wave effect, in the safety line and resonance in the supporting structure to which the top anchor is attached. In principle, in isolation a standing wave reversal of the fall arrest load at the top anchor can produce an increase in force acting on the top anchor to two times the force acting on the falling worker.

It is believed that the observed further increase in the force acting on the top anchor is produced by resonance in the supporting structure.

However, even if this explanation of the increase in force acting on the top anchor is incorrect, the increase in force still exists and must be dealt with.

It will be appreciated that such forces place a large strain on equipment, particularly the top anchor. Since safety is of paramount importance (as it is the purpose of the device), such systems must be designed to account for the multiplying force.

It is an object of the present invention to provide an improved fall arrest system that reduces the force to the top anchor.

In one broad aspect of the invention there is provided a fall arrest system including a cable for mounting between a first and second anchor point and a fall arrest device adapted for movement along said cable, wherein an energy absorbing means is associated with either the first anchor point or the fall arrest device or both.

In a first aspect, this invention provides a fall arrest system comprising an upper anchor point and a lower anchor point and a vertical cable mounted between the anchor points, and further comprising a first energy absorbing means associated with the upper anchor point.

Preferably the first anchor point is located at an upper end of a vertically mounted cable.

Preferably the second anchor point is located at a lower end of a vertically mounted cable and provides an additional “extension” to the system. By way of example these and anchor point way include elements which are deformable or include a slip (clutch) element.

The present invention is explained hereinafter by way of example with reference to the accompanying figures that illustrate preferred embodiments of the fall arrest system.

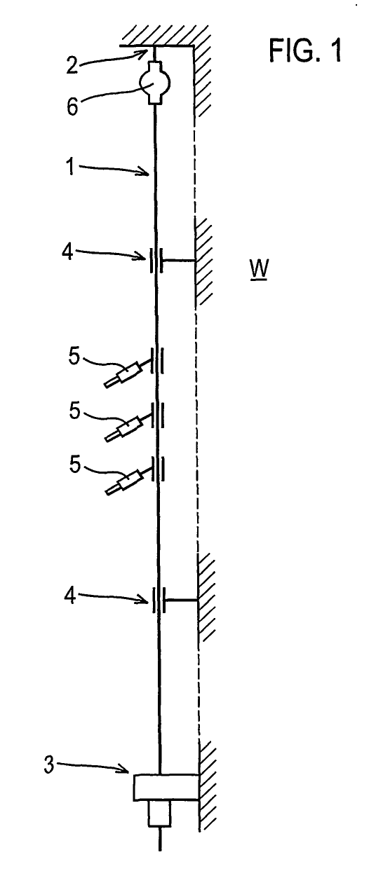

FIG. 1 shows a fall arrest system according to a first embodiment of the invention; and

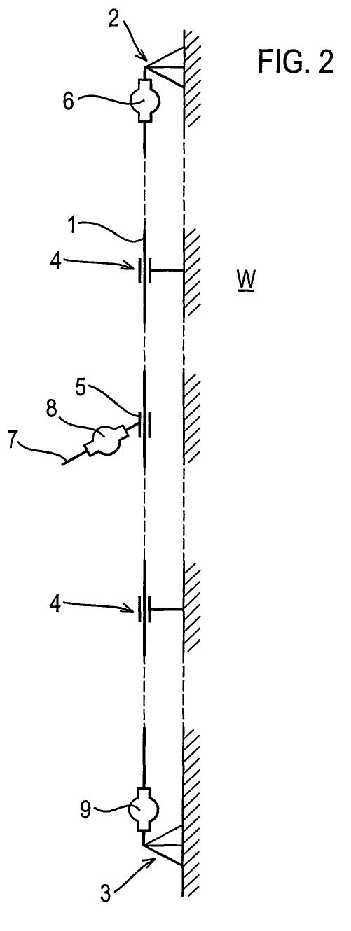

FIG. 2 shows a fall arrest system according to a second embodiment of the invention.

The attached FIG. 1 illustrates the components for realising a first embodiment of the present invention, namely a cable or safety line 1, secured between a top anchor point 2 and a bottom anchor point 3. Further, the safety line 1 may be retained by one or more cable guides 4 and one or more fall arrest devices 5 can be mounted on the safety line 1. The safety line is pre-tensioned as known in the art and, for the purposes of illustration, is situated adjacent the vertical wall W of a building.

The present invention reduces the loads applied to the top anchor point 2 when a fall arrest event occurs by incorporating an energy absorption means with either the top anchor point 2 or a fall arrest device 5 or both. In FIG. 1 an “overload protector” 6 is installed adjacent the top anchor point 2. The overload protector 6 includes an energy absorber. Thus when a shock is experienced by the system due to arrest of a falling worker, part of the energy is absorbed by the overload protector 6 opposed to being applied to the fixed top anchor point 2.

In general the overload protector 6 can incorporate any known type of energy absorber. The overload protector 6 reduces the force acting on the top anchor point 2 when a fall arrest event occurs by allowing extension or relative movement of the safety line 1 away from the top anchor point 2. This extension or relative movement absorbs part of the load and energy which would otherwise be applied to the top anchor point 2 and eliminates or dissipates the affects of standing waves in the safety line 1.

As a result, the overload protector 6 can reduce the load applied to the top anchor point 2 to the expected level equal to, or approximately equal to, the force acting on the falling worker.

In a similar way an energy absorber could be associated with the fall arrest devices, possibly as part of a worker harness, not illustrated in FIG. 1. Such an energy absorber improves comfort for a worker by reducing the “jolt” experienced when a fall is arrested and also reduces the immediate “pull” on safety line 1, most of the energy of which is ordinarily transferred to the fixed anchor point 2.

As another alternative an energy absorber could be associated with the bottom anchor point 3 of the safety line 1 instead of, or in addition to the top anchor point 2. Similarly to the arrangement at the top anchor point 2, the energy absorber at the bottom anchor point 3 could be located between the safety line 1 and a bottom anchor bracket, between the bottom anchor bracket and the fixed supporting structure or be within or integral with the bottom anchor bracket.

The combination of energy absorbers in fall arrest devices and anchor points improves the load capability of the overall system and design freedom. However, the invention may be realised without necessarily installing energy/shock absorbers to both.

Accordingly, use of an energy absorber according to the present invention in a fall arrest system allows the problem of the load applied to an upper anchor point being larger than the force acting on a falling worker to be eliminated or reduced. As a result, in a fall arrest system using an energy absorber or energy absorbers according to the present invention it is only necessary for the system components to be designed to cope with an applied load substantially equal to the force acting on a falling worker. As a result the undesirable increase in costs and weight of providing system components, and particularly the top anchor components forming the top anchor point connecting the cable to a supporting structure, designed to cope with loads up to three times the force acting on a falling worker and still maintain an adequate margin of safety is avoided.

Further, there are many existing installed fall arrest systems which have been designed only to deal with applied loads throughout the system substantially equal to the force acting on a falling worker without it being appreciated that the force acting on the top anchor could be significantly greater than and up to three times this force. As result these existing installed systems are likely to be subject to unsafe loads when a fall arrest event occurs. By adding an energy absorber according to the present invention to such existing fall arrest systems, the requirement which would otherwise arise of replacing at least some parts of these existing systems, and in particular the top anchor components, with stronger components can be avoided.

As explained above, in principle any type of energy absorbing element could be used in the present invention. However, it is believed that some types of energy absorbing element would be particularly advantageous.

One suitable type of energy absorbing element or elements are plastic extension type energy absorbers in which the energy absorber contains a store of plastically deformable material. This material is deployed while undergoing plastic deformation and so absorbs energy when subject to a predetermined applied load. The energy absorbing device can be conveniently produced from a strip or rod which is coiled or wrapped in such a way that it unwinds and undergoes plastic deformation, so allowing the device as a whole to extend when subject to a predetermined force and thereby absorbing energy and dissipating the standing wave.

Other forms of plastic deformation based energy absorber could also be used, such as devices in which a nut or other outwardly projecting element is forced along the interior of a tube having an internal cross section smaller then the size of the nut or element so resulting in plastic deformation of the tube.

Alternatively, the plastic deformation type energy absorber could be integral with the top anchor itself. In this arrangement the top anchor could include an anchor bracket having a section which will bend or buckle plastically in response to a predetermined applied load. In such an arrangement where the top anchor structure itself plastically deforms in order to absorb energy it should be understood that the extension of the system would be the extension of the safety line relative to the attachment point of the top anchor to the fixed supporting structure.

Another suitable type of energy absorber would be an energy absorbing element or elements using elastic deformation to absorb energy. Such elastic energy absorbing devices could be similar in type to the energy absorbers relying on plastic deformation discussed above but using elastic deformation instead of plastic deformation.

Where an elastically deforming energy absorber is to be used one particularly simple arrangement is to arrange a resilient element such as, for example, a tension spring in the load path between the cable 1 and the top anchor point 2.

In practice it is expected that energy absorbers using plastic deformation will be preferred to energy absorbers using elastic deformation because plastically deforming energy absorbers are generally able to absorb more energy for a given size or weight of energy absorber. Further, in many fall arrest systems it is a requirement to replace some system components after a fall arrest event has occurred. In order to ensure that this is done the use of plastically deforming energy absorbing elements which undergo irreversible deformation and so leave clear evidence that a fall arrest event has occurred may be preferred.

A further type of energy absorber which can be used is a slipping device including a friction or clutch element arrange to respond to a predetermined applied load by allowing relative movement of the safety line 1 and top anchor point 2.

Another energy absorber which could be used in the present invention would be a textile webbing type energy absorber responding to a predetermined applied load by tearing and so absorbing energy and allowing relative movement of the safety line 1 and the top anchor point 2.

In FIG. 1, the top anchor point 2 is shown as a point at which the overload protector 6 is connected to the fixed support structure. In practice there will generally be a top anchor structure connecting the safety line 1, or the overload protector 6, to the fixed supporting structure. In the above discussion references to extension of the system or relative movement of the safety line 1 should be understood as referring to extension or relative movement of the safety line 1 relative to the fixed supporting structure or the point of attachment of the top anchor point 2 to the fixed supporting structure. This extension or relative movement can be provided by the overload protector 6 being located between the safety line 1 and the top anchor structure so that the relative movement occurs between the safety line 1 and the top anchor structure. Alternatively, the overload protector 6 could be incorporated within the top anchor structure so that the relative movement or extension takes place by deformation or extension of the top anchor structure itself as convenient.

The examples of energy absorbers discussed above are discussed in terms of an energy absorber located at the top end of the safety line 1 located adjacent to or as a part of the top anchor structure. All of the discussed types of energy absorber are equally applicable to use in the proposed alternative positions at the bottom 3 of the safety line or as a part of or associated with the fall arrest device 5.

A second preferred embodiment of the fall arrest system according to the invention is shown in FIG. 2. The system in FIG. 2 is formed by a cable or safety line 1 secured between a top anchor point 2 and a bottom anchor point 3 similarly to the first embodiment. The safety line 1 may be retained by one or more cable guides 4. The top anchor point 2, bottom anchor point 3 and any cable guides 4 are attached to a fixed supporting structure, as indicated in FIG. 2 for the purpose of illustration by a vertical wall of a building.

In use, one or more fall arrest devices 5 are mounted on the cable 1. Each fall arrest device 5 is connected to a safety lanyard 7 attaching personal safety equipment such as a harness (not shown) to a fall arrest device 5. The fall arrest device 5 is arranged to be able to move along the safety line 1 and if necessary to traverse the cable guides 4 to follow normal movement of a worker and to respond to a fall event by gripping the safety line 1 and so arresting the fall of the worker.

A number of fall arrest devices clamping to a safety line 1 in different ways are known and the present invention is not dependent upon the type of fall arrest device 5 used.

The fall arrest device 5 has an associated energy absorber 8 arranged to limit the load applied to a falling worker when a fall is arrested by the fall arrest device 5. In FIG. 2, the illustrated energy absorber 8 is between the fall arrest device 5 and the safety lanyard 7 so that the load applied to a falling worker along the safety lanyard 7 is limited to a safe level. The energy absorber 8 could be located at any other point in the load path between the worker and the fall arrest device 5 as convenient. For example, the personal energy absorber 8 may be provided as part of the personal safety harness, for example as back pack type device connected by the safety lanyard 7 to the fall arrest device 5.

When a fall arrest event occurs by clamping or locking of the fall arrest device 5 onto the safety line 1 the fall arrest load limited by the personal energy absorber is applied to the worker to arrest their fall and a corresponding load is applied to the safety line 1 through the fall arrest device 5. In order to prevent overloading of the top anchor point 2 by the fall arrest load applied to the safety line 1 by the fall arrest device 5 an overload protector 6 is provided at the top anchor point 2. The overload protector 6 allows movement of the safety line 1 relative to the top anchor point 2, or the supporting fixed structure, when the load applied to the top anchor point 2 exceeds a threshold in order to prevent overloading of the top anchor point 2, as in the first embodiment.

The advantage of the second is that the overload protector 6 and personal energy absorber 8 can be arranged to respond to different levels of applied load as required in the specific system in order to prevent injury to the falling worker or damage to the upper anchor point 2 or supporting fixed structure respectively.

Preferably, the system also includes an extension device 9 associated with the bottom anchor point 3 allowing upward movement of the bottom of the safety line 1 relative to the bottom anchor point 3. The use of such an extension or slip device 9 associated with the bottom anchor point 3 in combination with the overload protector 6 associated with the top anchor point 2 allows better control and limiting of the applied loads.

Preferably, the extension device 9 is an energy absorber.

Alternatively, the arrangement of the overload protector 6 and extension device 9 could be reversed.

In the above description the force acting on a worker when a fall arrest occurs is referred to. Use of a safety system for workers is the most common usage of a fall arrest system. However, the present invention is equally applicable to fall arrest systems when used to secure other items such as equipment or cargo instead of workers.

In a preferred form of the invention the bottom anchor point 3 includes a mechanism that provides additional extension to the system in addition to an energy absorber located elsewhere in the system. Such a mechanism may be to include a deformable element or slip device, such as a clutch that acts when a force is introduced to the system. This feature, combined with energy/shock absorption brings forces resulting from fall arrest, as applied to the top anchor, down to acceptable levels.

In practice a fall will generally apply a side load to the safety line 1 in addition to the load along the safety line 1. This side load will produce tension in both directions along the safety line 1 so that the load applied to the top anchor point can be controlled and limited by allowing extension of the safety line 1 at the bottom anchor point using an extender device, energy absorber or load limiter.

Accordingly, the present invention can reduce the “three times” force discovered during testing of existing vertical cable systems.

What is claimed is:

1. A fall arrest system comprising an upper anchor point and a lower anchor point and a vertical cable mounted between the anchor points, and further comprising a first energy absorbing means associated with the upper anchor point.

2. A fall arrest system according to claim 1, in which the first energy absorbing means is adapted to control the load applied to the upper anchor point.

3. A fall arrest system according to claim 1, and further comprising a fall arrest device mounted on the vertical cable and a second energy absorbing means associated with the fall arrest device, in which the second energy absorbing means is adapted to control the load experienced by a user and the first energy absorber is adapted to control the load applied to the upper anchor point.

4. A fall arrest system according to claim 1, in which the lower anchor point is arranged to provide an additional extension of the system.

5. A fall arrest system according to claim 4, in which the lower anchor point includes a slip element.

6. A fall arrest system according to claim 4, in which the lower anchor point is deformable.

7. A fall arrest system according to claim 1, in which the upper and lower anchor points are at the upper and lower ends of the cable.

8. A fall arrest system according to claim 1 and further comprising a fall arrest device arranged for movement along the cable.

9. A fall arrest system according to claim 8, in which the fall arrest device comprises an energy absorbing means.

10. A fall arrest system according to claim 1 and further comprising one or more cable guides.

11. A fall arrest system according to claim 4, in which the additional extension of the system is provided by a third energy absorbing means associated with the lower anchor point.

12. A fall arrest system according to claim 1, in which at least one of the energy absorbers is resilient.

13. A fall arrest system according to claim 12, in which said resilient energy absorber is a spring.

14. A fall arrest system according to claim 1, in which at least one of the energy absorbers includes a plastically deformable element.
